(19) United States
(12) Patent Application Publication
(10) Pub. No.: US 2018/0300735 A1
(43) Pub. Date: Oct. 18, 2018

(54) SYSTEMS AND METHODS FOR LABOR RESOURCE CAPACITY MODELING WITH ASSOCIATED RATES IN AN INTEGRATED PROGRAM PORTFOLIO MANAGEMENT SOLUTION

(71) Applicant: JPMorgan Chase Bank. N.A., New York, NY (US)

(72) Inventors: Keith A. Zimmerer, Westerville, OH (US); George Robertson, West Chester, PA (US); Lyn Hublein, Hockessin, DE (US)

(21) Appl. No.: 15/952,374

(22) Filed: Apr. 13, 2018

Related U.S. Application Data
(60) Provisional application No. 62/485,138, filed on Apr. 13, 2017.
(60) Provisional application No. 62/485,140, filed on Apr. 13, 2017.

(51) Int. Cl. G06Q 30/02; G06Q 10/06

(52) U.S. Cl. CPC G06Q 30/0201; G06Q 10/0631

(57) ABSTRACT

Systems and methods for labor resource capacity modeling with associated rates in an integrated program portfolio management solution are disclosed. In one embodiment, an organization's labor capacity and the associated cost may be defined across discrete time periods and managed distinct from the demand and associated financial budget defined within a portfolio of programs. Capacity and demand may be reflected together such that an organization may satisfy portfolio demand by adjusting capacity and demand independently.

### RELATED APPLICATIONS

This application claims priority to U.S. Provisional Patent Application Ser. No. 62/485,138, filed Apr. 13, 2017 and U.S. Provisional Patent Application Ser. No. 62/485,140, filed Apr. 13, 2017. The disclosures of each of these documents is hereby incorporated, by reference, in its entirety.

### BACKGROUND OF THE INVENTION

### 1. Field of the Invention

The present disclosure generally relates to systems and methods for labor resource capacity modeling with associated rates in an integrated program portfolio management solution.

### 2. Description of the Related Art

Organizations often need to manage their approved headcount (i.e., resource capacity) based on the organization's requested work (i.e., demand). It is difficult to balance this capacity against the demand and provide cost associated with labor capacity.

### SUMMARY OF THE INVENTION

Systems and methods for labor resource capacity modeling with associated rates in an integrated program portfolio management solution are disclosed. In one embodiment, an organization's labor capacity and the associated cost may be defined across discrete time periods and managed distinct from the demand and associated financial budget defined within a portfolio of programs. Capacity and demand may be reflected together such that an organization may satisfy portfolio demand by adjusting capacity and demand independently.

In one embodiment, in an information processing apparatus comprising at least one computer processor, a method for labor resource capacity modeling may include: (1) determining a work capacity of an organization for a period; (2) determining a draft headcount for the organization for the period based on the work capacity and the demand; (3) determining a monetization for the draft headcount for the period; (4) revising the draft headcount based on the monetization and a budget for the organization; and (5) revising the work capacity for the period based on the revised draft headcount.

In one embodiment, the method may further include determining a work demand for the organization for the period, and may include revising the work demand based on the revised work capacity.

In one embodiment, the work capacity may be a sum of available labor for the period.

In one embodiment, the work capacity may be retrieved from a human resources system.

In one embodiment, the work capacity may include a plurality of types of work capacity.

In one embodiment, the work capacity may be extrapolated based on historical work capacity data.

In one embodiment, the work demand may be determined based on information received from project management systems.

In one embodiment, machine learning may be used to determine work demand based on historical work demand for the period.

In one embodiment, the work demand may include a plurality of work taxonomies.

In one embodiment, the draft headcount may be based on a number of hours in the work demand divided by an hourly factor.

In one embodiment, the step of monetizing the draft headcount may include summing a cost for each head in the headcount for the period.

In one embodiment, the method may further include automatically adding or subtracting employees based on the revised headcount.

In one embodiment, the method may further include automatically reassigning employees based on the revised headcount.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for labor resource capacity modeling with associated rates in an integrated program portfolio management solution according to one embodiment;

FIG. 2 depicts a method for labor resource capacity modeling with associated rates in an integrated program portfolio management solution according to one embodiment; and

FIG. 3 depicts a business use model according to an exemplary embodiment.

### DETAILED DESCRIPTION OF PREFERRED EMBODIMENTS

Embodiments disclosed herein are directed to systems and methods for labor resource capacity modeling with associated rates in an integrated Program Portfolio Management (PPM) solution. In one embodiment, a Program Portfolio may include time-limited endeavors (e.g., projects and programs) and the required labor and capital resources with associated financial budget to deliver desired business outcomes (collectively, “demand”) balanced against available labor and capital resources with associated cost (collectively, “capacity”).

In one embodiment, a PPM solution may be executed by a computer processor, such as a server.

In one embodiment, rather than a demand-based system, embodiments are directed to a capacity-based system. An organization's capacity may be defined as the amount of work that its employees are capable of doing in a certain time period (e.g., an hour, day, week, month, quarter, etc.). That capacity may have a cost, which may be the cost for the workforce over that same time period (hourly, daily, weekly, monthly, etc.). The anticipated demand in the organization for resources may drive capacity decisions (e.g., adding headcount, reducing headcount, reassignments, etc.).

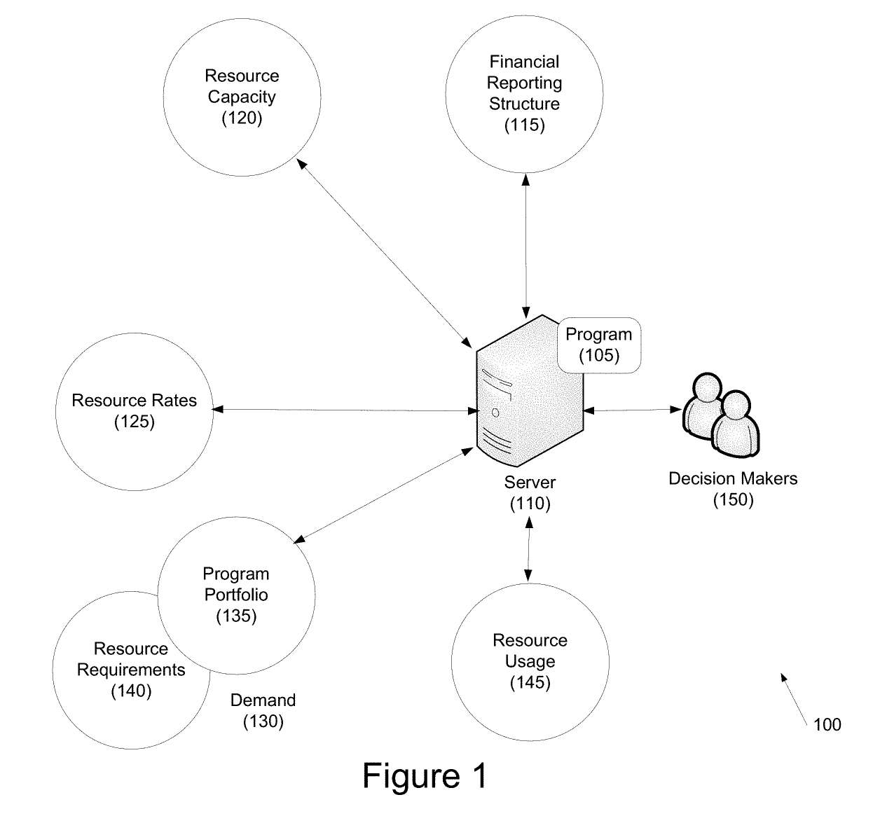

Referring to FIG. 1, a system for organizational planning is disclosed according to one embodiment. System 110 may include server 110 that may include one or more computer processors and may execute computer program or application 105 for organizational planning.

System 100 may further include financial reporting structure 115, which may provide a reporting structure for the organization. For example, financial reporting structure 155 may be derived from an organization's General Ledger (G/L) system such that the cost of capacity or expense associated with demand may be translated to support desired or mandatory financial reporting requirements.

System 100 may further include resource capacity 120, which may comprise a plurality of employees. In one embodiment, each employee may be associated with a work capacity and a cost for a time period. For example, each employee may be capable of performing a certain amount of work in a certain time period, yielding a capacity for that employee. The combined capacity for all employees may be the capacity for the organization for a time period, and the cost for all employees may be cost for the organization for that time period.

System 100 may include resource rates 125, which may be a rate associated with the resource. In one embodiment, the rates may vary depending on the type of resource, time period, demand, etc.

System 100 may further include demand 130 for resources. Demand 130 may be for any entity, including individuals, businesses, etc. Demand 130 may include program portfolio 135, which may include time-limited endeavors (e.g., projects, programs, etc.) with associated financial budget(s) to deliver desired business outcomes and, resource requirements 140, which may be the required labor and capital resources.

System 100 may further include resource usage 145, which may include time actually spent or recorded by the labor force, an amount of capital resources consumed, etc. In one embodiment, resource usage 145 may be received from programs, such as HR programs, timekeeping programs, etc.

System 100 may further include input from decision makers 150, which may include personnel from a human resources staff, finance staff, project staff, etc. for the organization.

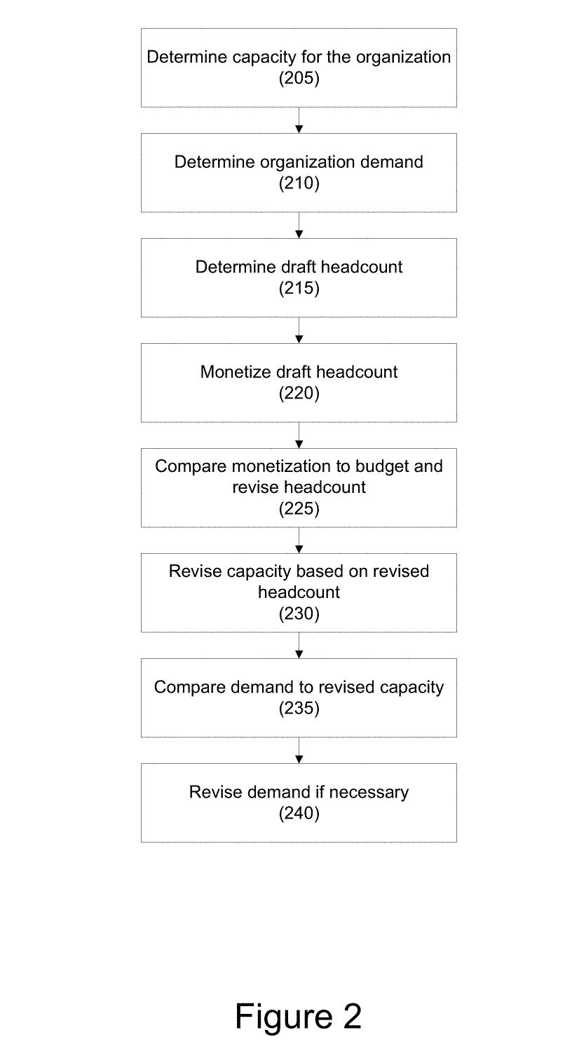

Referring to FIG. 2, a method for organizational planning is disclosed according to one embodiment.

In step 205, a capacity for an organization may be determined. In one embodiment, this may be the sum of all available labor (e.g., hours, headcount, and dollars) for a period of time. This may involve, for example, identifying employees and their availability to perform work. In one embodiment, the capacity may be broken into different types (e.g., employee, contractor, etc.) skill levels, skill sets, locations, roles, organization, or in any way as is necessary and/or desired.

In one embodiment, capacity information may be automatically retrieved from human resources systems. In one embodiment, capacity information may be automatically retrieved from human resources systems. The information that is retrieved may include, for example, the resource start and end dates, a work schedule (e.g., full-time versus part-time, daily/weekly schedule, planned time away such as vacation, sick time, etc.), etc. Capacity may be extrapolated and/or adjusted based on, for example, historical data (e.g., overtime patterns, vacation and holiday patterns, weather patterns, etc.), etc.

In step 210, an organization's demand for a certain time period may be determined. In one embodiment, this may be the known work that is required to be done, e.g., a “book of work.” This may be provided manually from project managers, automatically from other systems, etc.

In one embodiment, machine learning may be used to identify demand. For example, past demand may be used to estimate demand for a time period, and may take into account seasonal fluctuations, etc.

In one embodiment, demand may be broken into a taxonomy (e.g., management, administrative, production, etc.), project hierarchy (e.g., initiative, program, project, etc.), type (e.g., FTE, FTC), location, role/skill, organization, existing vs. open headcount, etc.).

In step 215, the demand and capacity may be reviewed to determine a draft headcount needed for the time period in question. For example, the draft headcount may be determined based on the demand for a time period. It may be calculated based on number of hours in the demand divided by an hourly factor that may be determined by the organization.

In step 220, the draft headcount may be monetized. For example, the cost of the headcount may be determined by determining the cost for each employee, and adding the costs together.

In step 225, the monetization may be compared to the budget, and any adjustments may be made so that the headcount meets the budget. This may result in a final headcount. For example, if the monetization is greater than the budget, then the headcount may be reduced.

In step 230, the capacity may be revised based on the revised headcount. For example, if the headcount changed in step 225, the capacity will most likely change due to the increase or decrease in the headcount.

In step 235, the demand may be compared to the revised capacity, and, if necessary, in step 240, the demand may be revised to align with capacity. For example, if the capacity (e.g., headcount, capital resources) decreased, the demand may also be decreased or deferred until capacity is available to satisfy the demand.

For example, additional capital resources may be automatically added to accommodate an increased headcount.

In step 240, additional actions may be taken. For example, employees or other resources may be increased, decreased, or assigned to a specific project; likewise, capacity based on a role may be assigned to a project.

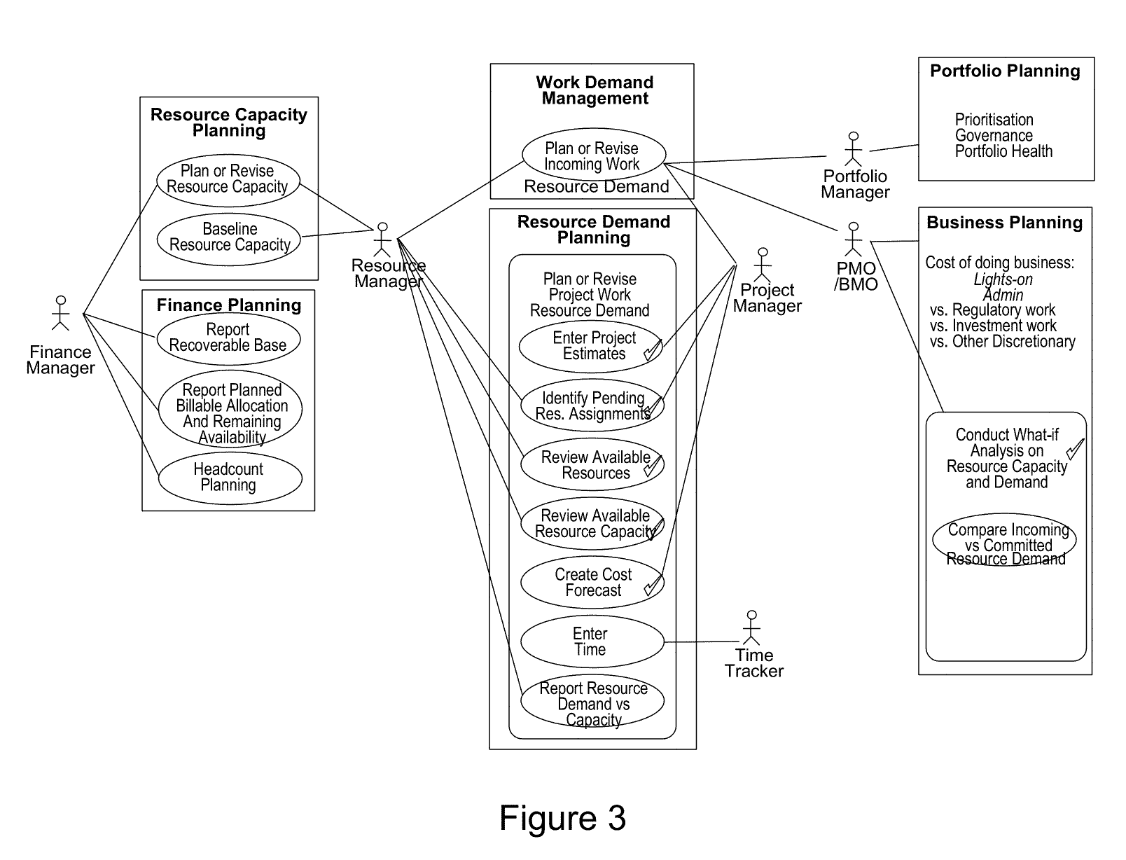

FIG. 3 depicts a business use model according to an exemplary embodiment. The model of FIG. 3 depicts Resource Capacity Planning, Finance Planning, Work Demand Management, Resource Demand Planning, Portfolio Planning, and Business Planning. For each element, sub-elements (e.g., plan or revise resource capacity, baseline resource capacity, etc.) as well as one or more responsible individual may be identified.

Although multiple embodiments have been disclosed, it should be recognized that these embodiments are not exclusive, and aspects and features from one embodiment may be used with other embodiments.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for labor resource capacity modeling comprising:
in an information processing apparatus comprising at least one computer processor:
determining a work capacity of an organization for a period;
determining a draft headcount for the organization for the period based on the work capacity and the demand;
determining a monetization for the draft headcount for the period;
revising the draft headcount based on the monetization and a budget for the organization; and
revising the work capacity for the period based on the revised draft headcount.

2. The method of claim 1, further comprising:
determining a work demand for the organization for the period.

3. The method of claim 2, further comprising
revising the work demand based on the revised work capacity.

4. The method of claim 1, wherein the work capacity comprises a sum of available labor for the period.

5. The method of claim 4, wherein the work capacity is retrieved from a human resources system.

6. The method of claim 4, wherein the work capacity comprises a plurality of types of work capacity.

7. The method of claim 1, wherein the work capacity is extrapolated based on historical work capacity data.

8. The method of claim 2, wherein the work demand is determined based on information received from project management systems.

9. The method of claim 2, wherein machine learning is used to determine work demand based on historical work demand for the period.

10. The method of claim 2, wherein the work demand comprises a plurality of work taxonomies.

11. The method of claim 1, wherein the draft headcount is based on a number of hours in the work demand divided by an hourly factor.

12. The method of claim 1, wherein the step of monetizing the draft headcount comprises summing a cost for each head in the headcount for the period.

13. The method of claim 1, further comprising:
automatically adding or subtracting employees based on the revised headcount.

14. The method of claim 1, further comprising:
automatically reassigning employees based on the revised headcount.
